(19) United States
(12) Patent Application Publication
(10) Pub. No.: US 2023/0237565 A1
(43) Pub. Date: Jul. 27, 2023

(54) METHOD AND SYSTEM FOR BULK ASSET LEASING

(71) Applicant: BlackBerry Limited, Waterloo (CA)

(72) Inventors: Andrew KUGLER, Ottawa (CA); Michael BRIMNER, Ottawa (CA)

(21) Appl. No.: 18/128,116

(22) Filed: Mar. 29, 2023

Related U.S. Application Data
(63) Continuation of application No. 16/131,661, filed on Sep. 14, 2018.

(51) Int. Cl. G06Q 30/0645; G06Q 50/28

(52) U.S. Cl. CPC G06Q 30/0645; G06Q 50/28

(57) ABSTRACT

A method at a computing device within an asset management system, the method including receiving a leasing indication at the computing device, the leasing indication providing at least one asset in the asset management system is leased to a lessee; duplicating an asset record for each of the at least one asset, created a duplicated record; assigning a policy based on the lessee to the duplicated record; and providing a pointer within the asset record to the duplicated record.

### FIELD OF THE DISCLOSURE

The present disclosure relates to the transportation of goods, and in particular relates to leasing of transportation assets.

### BACKGROUND

During the transporting goods, often specific types of assets are required by a transportation company. In some cases, the transportation company may have excess assets and may be willing to lease those assets to other companies to avoid the asset sitting idly.

In other cases, a transportation company may require assets and may signal to other companies that such assets are required in order to determine whether another transportation company may have excess assets to lease to the transportation company.

The assigning of assets to a lessee, tracking and assigning of policies to such assets, and return of such assets to the lessor is difficult.

### BRIEF DESCRIPTION OF THE DRAWINGS

The present disclosure will be better understood with reference to the drawings, in which:

FIG. 1 is a block diagram showing an example container yard;

FIG. 2 is a block diagram of an example sensor apparatus capable of being used with the embodiments herein;

FIG. 3 is a block diagram showing communications between servers and shipping containers;

FIG. 4 is an example user interface for leasing of transportation assets;

FIG. 5 is a block diagram showing entries in a database for asset management;

FIG. 6 is a block diagram showing entries in a database for asset management in which leased assets are temporarily duplicated;

FIG. 7 is a process diagram showing a process at a server for leasing and returning an asset;

FIG. 8 is a process diagram showing a process at a server for applying different policies to event data from a sensor apparatus; and

FIG. 9 is a block diagram of an example computing device capable of being used in accordance with the embodiments of the present disclosure.

### DETAILED DESCRIPTION

The present disclosure provides a method at a computing device within an asset management system, the method comprising: receiving a leasing indication at the computing device, the leasing indication providing at least one asset in the asset management system is leased to a lessee; duplicating an asset record for each of the at least one asset, created a duplicated record; assigning a policy based on the lessee to the duplicated record; and providing a pointer within the asset record to the duplicated record.

The present disclosure further provides a computing device within an asset management system, the computing device comprising: a processor; and a communications subsystem, wherein the computing device is configured to: receive a leasing indication at the computing device, the leasing indication providing at least one asset in the asset management system is leased to a lessee; duplicate an asset record for each of the at least one asset, created a duplicated record; assign a policy based on the lessee to the duplicated record; and provide a pointer within the asset record to the duplicated record.

The present disclosure further provides a computer readable medium for storing instruction code which, when executed by a processor of a computing device within an asset management system, cause the computing device to: receive a leasing indication at the computing device, the leasing indication providing at least one asset in the asset management system is leased to a lessee; duplicate an asset record for each of the at least one asset, created a duplicated record; assign a policy based on the lessee to the duplicated record; and provide a pointer within the asset record to the duplicated record.

The present disclosure relates to a computing system or database in which customers of an asset management system may more simply lease assets between each other. In one embodiment, each customer may be a transportation company that subscribes to a transportation management system. The transportation management system may include a database with assets for a plurality of customers, each customer of the transportation management system having visibility only of its own assets.

A customer or lessor can have multiple leasing partners and many assets. It can be time-consuming to individually select assets and assign them to other customer leasing partners. Further, it can be time consuming for the lessee to assign policies to each asset that is being leased. Therefore, in accordance with the present disclosure, group selection of assets for the assigning of assets to a lessor is provided. For example, in one case a group of assets can be dragged together on a desktop screen or mobile device and placed into an icon, box or area associated with a lessee.

In some cases, a list of potential customer lessees can be made available while the assets are being dragged. In other cases, a leasing screen can be entered and the names or lists of lessees can be fixed on the screen. The lessees can be represented by a box, bucket or other means with the customer name as the lessee.

The selected assets may be dropped onto the customer box, which may then automatically assign these assets to the lessee. The automatic assigning of the assets may include temporary duplication of the database entries for such assets to associate such assets with both the lessor and the lessee. In this regard, policies for notification of events or other actions associated with the asset may be based on defaults preconfigured by the lessee. For example, thresholds for low temperature warnings, geofence areas required for notification, acceleration event thresholds, deceleration event thresholds, among other configurable parameters may be preconfigured by the lessee and every asset assigned to the lessee may be assigned such as default policy. The lessee could then change the policy for each specific asset in some cases.

The policy for the asset may therefore differ between the lessor and the lessee.

In one embodiment, if an asset is leased, notification based on the varied policy between the lessor and the lessee may be made to the respective lessor or lessee based on the different policies.

In some embodiments, a lessor can confirm an intention to lease the assets, for example by providing an “Are you sure?” pop up, among other options. On confirmation, the assets may be automatically considered to be leased.

In some cases, assets can also be dragged out of the lessee, back into the original lessor's pool of assets.

Further, once assets have been leased, optional triggers may be sent to a dispatcher to direct these assets to a specific geofence or location if desired. In this way, physical assets such as trucks or trailers will arrive at the lessee's geofence for use.

While the disclosure below considers assets to be trailers, this is not limiting. In other cases, railcars, ships, or other transportation assets may equally be utilized with the systems described herein. In still further cases, assets not related to the transportation of goods may also benefit from the systems and methods provided herein. The use of trailers is therefore only provided for illustration purposes.

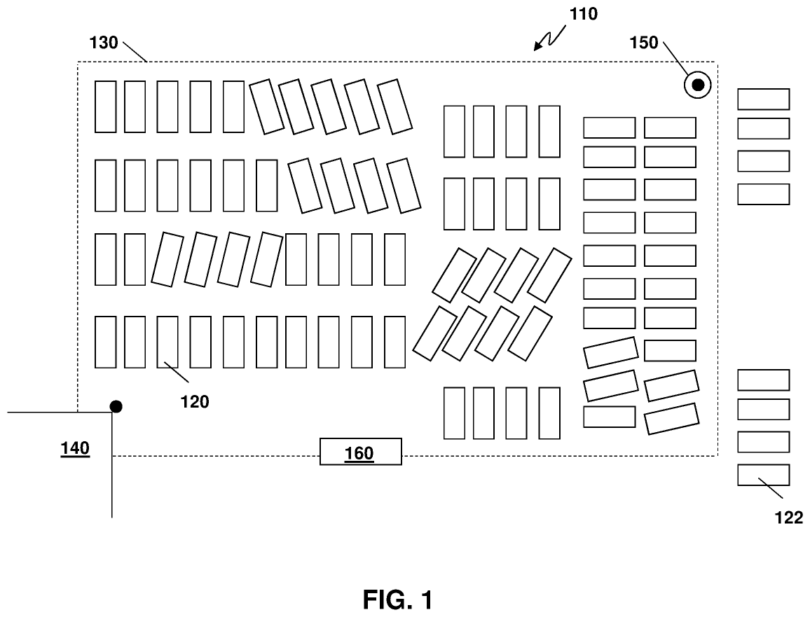

Reference is now made to FIG. 1, which shows a simplified environment of a shipping yard 110. Shipping yard 110 includes a plurality of shipping containers 120. In some cases, the shipping containers 120 may be within a fenced area 130. However, due to the dynamic nature of the shipping yard, some containers, shown with reference 122, are outside of the fenced area 130. Further, in many cases shipping yard 110 may simply be too big to have a fenced area 130. In many cases, the shipping yard 110 will have a geofence associated with the yard.

Fixed infrastructure points within the shipping yard 110 may exist. For example, a building 140 or a fixed structure 150 such as a lamppost, security pole, or crane, among other options, may exist within the shipping yard 110.

Shipping containers 120 or 122 may be placed in rows, or stacked, or simply deposited in an empty location.

A shipping yard may have fixed ingress or egress points 160, which may allow for control of assets entering or exiting the yard and also may allow for a count of assets within the yard.

In accordance with one aspect of the present disclosure, all or a subset of the vehicles or trailers within the shipping yard may include a sensor apparatus. In particular, in one embodiment, a subset of containers 120 or 122 may have associated therewith a sensor apparatus that can be triggered to obtain information about the trailer or vehicle and communicate the results to a centralized server.

Thus, in the embodiments of the present disclosure, sensor systems may be included on the vehicle. A transportation company may have a plurality of sensor apparatuses operating remotely from a central monitoring station to provide remote sensor data to a management or monitoring hub. The sensors may be placed on a trailer, shipping container or similar product to provide a central station with information regarding the container. Such information may include, but is not limited to, information concerning the current location of the trailer or shipping container, the temperature inside the shipping container or trailer, operational parameters such as tire pressure or engine temperature, that the doors on the shipping container or trailer are closed, whether a sudden acceleration or deceleration event has occurred, the tilt angle of the trailer or shipping container, whether the trailer is loaded or unloaded, among other data. In some cases, the sensor apparatus merely provides the location of the trailer, and no other sensor information is provided.

In other embodiments the sensor apparatus may be secured to a vehicle itself. As used herein, the term vehicle can include any motorized vehicle such as a truck, tractor, car, boat, motorcycle, snow machine, among others, and can further include a trailer, shipping container or other such cargo moving container, whether attached to a motorized vehicle or not.

In accordance with the embodiments described herein, a sensor apparatus may be any apparatus or computing device that is capable of providing data or information from sensors associated with the sensor apparatus to a central monitoring or control station. Sensors associated with the sensor apparatus may either be physically part of the sensor apparatus, for example a built-in global navigation satellite system (GNSS) chipset, or may be associated with the sensor apparatus through short range wired or wireless communications. For example, a tire pressure monitor may provide information through a Bluetooth™ Low Energy (BLE) signal from the tire to the sensor apparatus. In other cases, a camera may be part of the sensor apparatus or may communicate with a sensor apparatus through wired or wireless technologies. Other examples of sensors are possible.

A central monitoring station may be any server or combination of servers that are remote from the sensor apparatus. The central monitoring station can receive data from a plurality of sensor apparatuses.

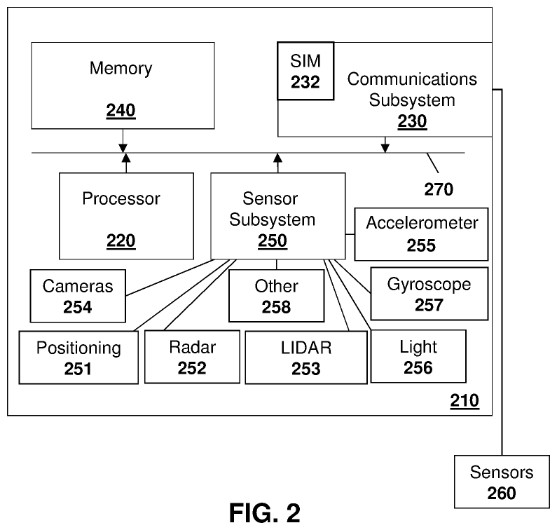

One sensor apparatus is shown with regard to FIG. 2. The sensor apparatus of FIG. 2 is however merely an example and other sensor apparatuses could equally be used in accordance with the embodiments of the present disclosure.

Reference is now made to FIG. 2, which shows an example sensor apparatus 210. Sensor apparatus 210 can be any computing device or network node. Such computing device or network node may include any type of electronic device, including but not limited to, mobile devices such as smartphones or cellular telephones. Examples can further include fixed or mobile devices, such as internet of things devices, endpoints, home automation devices, medical equipment in hospital or home environments, inventory tracking devices, environmental monitoring devices, energy management devices, infrastructure management devices, vehicles or devices for vehicles, fixed electronic devices, among others.

Sensor apparatus 210 comprises a processor 220 and at least one communications subsystem 230, where the processor 220 and communications subsystem 230 cooperate to perform the methods of the embodiments described herein. Communications subsystem 230 may, in some embodiments, comprise multiple subsystems, for example for different radio technologies.

Communications subsystem 230 allows sensor apparatus 210 to communicate with other devices or network elements. Communications subsystem 230 may use one or more of a variety of communications types, including but not limited to cellular, satellite, Bluetooth™, Bluetooth™ Low Energy, Wi-Fi, wireless local area network (WLAN), near field communications (NFC), ZigBee, wired connections such as Ethernet or fiber, among other options.

As such, a communications subsystem 230 for wireless communications will typically have one or more receivers and transmitters, as well as associated components such as one or more antenna elements, local oscillators (LOs), and may include a processing module such as a digital signal processor (DSP). As will be apparent to those skilled in the field of communications, the particular design of the communication subsystem 230 will be dependent upon the communication network or communication technology on which the sensor apparatus is intended to operate.

If communications subsystem 230 operates over a cellular connection, a subscriber identity module (SIM) 232 may be provided to allow such communication. SIM 232 may be a physical card or may be virtual. In some embodiments SIM 232 may also be referred to as a universal subscriber identity module (USIM), as merely an identity module (IM), or as an embedded Universal Integrated Circuit Card (eUICC), among other options.

Processor 220 generally controls the overall operation of the sensor apparatus 210 and is configured to execute programmable logic, which may be stored, along with data, using memory 240. Memory 240 can be any tangible, non-transitory computer readable storage medium, including but not limited to optical (e.g., CD, DVD, etc.), magnetic (e.g., tape), flash drive, hard drive, or other memory known in the art.

Alternatively, or in addition to memory 240, sensor apparatus 210 may access data or programmable logic from an external storage medium, for example through communications subsystem 230.

In the embodiment of FIG. 2, sensor apparatus 210 may utilize a plurality of sensors, which may either be part of sensor apparatus 210 in some embodiments or may communicate with sensor apparatus 210 in other embodiments. For internal sensors, processor 220 may receive input from a sensor subsystem 250.

Examples of sensors in the embodiment of FIG. 2 include a positioning sensor 251, a RADAR sensor 252, a LIDAR 253, one or more image sensors 254, accelerometer 255, light sensors 256, gyroscopic sensors 257, and other sensors 258. Other sensors may be any sensor that is capable of reading or obtaining data that may be useful for sensor apparatus 210. However, the sensors shown in the embodiment of FIG. 2 are merely examples, and in other embodiments different sensors or a subset of sensors shown in FIG. 2 may be used. For example, in one embodiment of the present disclosure, only a positioning sensor is provided.

The positioning sensor may use a positioning subsystem such as a Global Navigation Satellite System (GNSS) receiver which may be, for example, a Global Positioning System (GPS) receiver (e.g. in the form of a chip or chipset) for receiving GPS radio signals transmitted from one or more orbiting GPS satellites. References herein to “GPS” are meant to include Assisted GPS and Aided GPS. Although the present disclosure refers expressly to the “Global Positioning System”, it should be understood that this term and its abbreviation “GPS” are being used expansively to include any GNSS or satellite-based navigation-signal broadcast system, and would therefore include other systems used around the world including the Beidou (COMPASS) system being developed by China, the multi-national Galileo system being developed by the European Union, in collaboration with China, Israel, India, Morocco, Saudi Arabia and South Korea, Russia's GLONASS system, India's proposed Regional Navigational Satellite System (IRNSS), and Japan's proposed QZSS regional system.

Another sort of positioning subsystem may be used as well, e.g. a radiolocation subsystem that determines its current location using radiolocation techniques. In other words, the location of the device can be determined using triangulation of signals from in-range base towers, such as used for Wireless E911. Wireless Enhanced 911 services enable a cell phone or other wireless device to be located geographically using radiolocation techniques such as (i) angle of arrival (AOA) which entails locating the caller at the point where signals from two towers intersect; (ii) time difference of arrival (TDOA), which uses multilateration like GPS, except that the networks determine the time difference and therefore the distance from each tower; and (iii) location signature, which uses “fingerprinting” to store and recall patterns (such as multipath) which mobile phone signals exhibit at different locations in each cell. A Wi-Fi™ Positioning System (WPS) may also be used as a positioning subsystem. Radiolocation techniques and/or WPS may also be used in conjunction with GPS in a hybrid positioning system

Other sensors may be external to the sensor apparatus 210 and communicate with the sensor apparatus 210 through, for example, communications subsystem 230. Such other sensors are shown as sensors 260 and the embodiment of FIG. 2. For example, a tire pressure monitoring system may communicate over short range communications such as Bluetooth™ Low Energy with communications subsystem 230 on the sensor apparatus 210. Other examples of sensors 260 are possible.

Further, the sensor apparatus 210 of FIG. 2 may, in some embodiments, act as a gateway, and may communicate with other sensor apparatuses (not shown) on the trailer, where the other sensor apparatuses may act as hubs for a subset of the sensors on the vehicle or trailer.

Communications between the various elements of sensor apparatus 210 may be through an internal bus 270 in one embodiment. However, other forms of communication are possible.

Sensor apparatus 210 may be affixed to any fixed or portable platform. For example, sensor apparatus 210 may be affixed to shipping containers, truck trailers, truck cabs in one embodiment. In other embodiments, sensor apparatus 210 may be affixed to any vehicle, including motor vehicles (e.g., automobiles, cars, trucks, buses, motorcycles, etc.), aircraft (e.g., airplanes, unmanned aerial vehicles, unmanned aircraft systems, drones, helicopters, etc.), spacecraft (e.g., spaceplanes, space shuttles, space capsules, space stations, satellites, etc.), watercraft (e.g., ships, boats, hovercraft, submarines, etc.), railed vehicles (e.g., trains and trams, etc.), and other types of vehicles including any combinations of any of the foregoing, whether currently existing or after arising, among others.

Typically, once affixed, the sensor apparatus may be registered with a computing device or server to allow a correlation of an asset type with the sensor apparatus. Thus, if the sensor apparatus is associated with a particular trailer type, such information may be provided to a server or computing device to all allow for asset management or leasing utilizing such sensor apparatus.

In other cases, sensor apparatus 210 could be carried by a user.

Such sensor apparatus 210 may be a power limited device. For example, sensor apparatus 210 could be a battery-operated device that can be affixed to a shipping container or trailer in some embodiments. Other limited power sources could include any limited power supply, such as a small generator or dynamo, a fuel cell, solar power, among other options.

In other embodiments, sensor apparatus 210 may utilize external power, for example from the engine of a tractor pulling the trailer, from a land power source for example on a plugged in recreational vehicle or from a building power supply, among other options.

External power may further allow for recharging of batteries to allow the sensor apparatus 210 to then operate in a power limited mode again. Recharging methods may also include other power sources, such as, but not limited to, solar, electromagnetic, acoustic or vibration charging.

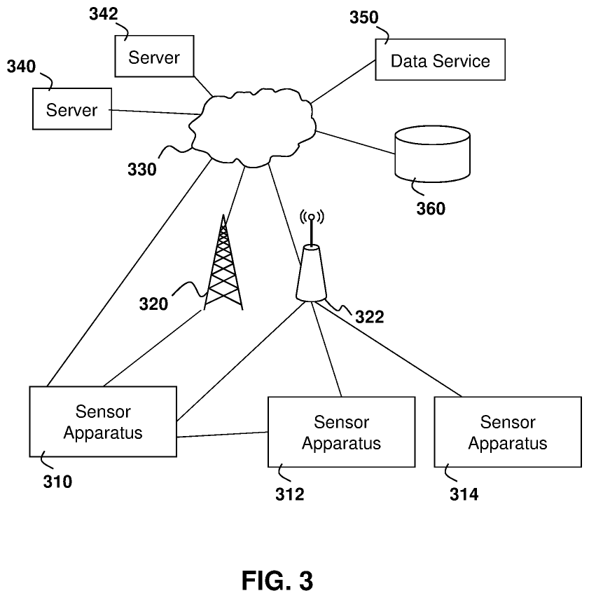

The sensor apparatus from FIG. 2 may be used in a variety of environments. One example environment in which the sensor apparatus may be used is shown with regard to FIG. 3.

Referring to FIG. 3, three sensor apparatuses, namely sensor apparatus 310, sensor apparatus 312, and sensor apparatus 314 are provided.

In the example of FIG. 3, sensor apparatus 310 may communicate through a cellular base station 320 or through an access point 322. Access point 322 may be any wireless communication access point. For example, access point 322 may be a WiFi router or a private router network. Also, a private router network may have a path from the access point name (APN) to a server, and may reduce network latency based on a location of the sensor apparatus in some embodiments.

Further, in some embodiments, sensor apparatus 310 could communicate through a wired access point such as Ethernet or fiber, among other options.

The communication may then proceed over a wide area network such as Internet 330 and proceed to servers 340 or 342.

Similarly, sensor apparatus 312 and sensor apparatus 314 may communicate with servers 340 or server 342 through one or both of the base station 320 or access point 322, among other options for such communication.

In other embodiments, any one of sensors 310, 312 or 314 may communicate through satellite communication technology. This, for example, may be useful if the sensor apparatus is travelling to areas that are outside of cellular coverage or access point coverage.

In other embodiments, sensor apparatus 312 may be out of range of access point 322 and may communicate with sensor apparatus 310 to allow sensor apparatus 310 to act as a relay for communications.

Communication between sensor apparatus 310 and server 340 may be one directional or bidirectional. Thus, in one embodiment sensor apparatus 310 may provide information to server 340 but server 340 does not respond. In other cases, server 340 may issue commands to sensor apparatus 310 but data may be stored internally on sensor apparatus 310 until the sensor apparatus arrives at a particular location. In other cases, two-way communication may exist between sensor apparatus 310 and server 340.

A server, central server, processing service, endpoint, Uniform Resource Identifier (URI), Uniform Resource Locator (URL), back-end, and/or processing system may be used interchangeably in the descriptions herein. The server functionality typically represents data processing/reporting that are not closely tied to the location of sensor apparatuses 310, 312, 314, etc. For example, the server may be located essentially anywhere so long as it has network access to communicate with sensor apparatuses 310, 312, 314, etc.

Server 340 may, for example, be an asset management system. In this case, server 340 may receive information from sensor apparatuses associated with various trailers or cargo containers, providing information such as the location of such cargo containers, the temperature within such cargo containers, system information such as tire pressure or vibration sensor readings, any unusual events including sudden decelerations, temperature warnings when the temperature is either too high or too low, cargo load levels within the trailer, whether the trailer is currently being used or is reserved for a future time, among other data. The server 340 may compile such information and store it for future reference. It may further alert an operator. For example, idle assets may be alerted to an operator or the need for further assets may be reported to an operator.

In other cases, server 340 may compile information regarding estimated arrival times or departure times at a shipping yard. This information may include delivery schedules for the trailer.

Other examples of functionality for server 340 are possible.

In the embodiment of FIG. 3, servers 340 and 342 may further have access to third-party information or information from other servers within the network. For example, a data services provider 350 may provide information to server 340. Similarly, a data repository or database 360 may also provide information to server 340.

For example, data services provider 350 may be a subscription-based service used by server 340 to obtain current road and weather conditions. In other cases, data services provider 350 may be a computing system operated by a border agency to provide data on general border conditions or on specific border crossings for vehicles in a fleet. In other cases, the data services provider 350 may be associated with a customer of the transportation company and provide order scheduling and delivery requirements. Other functionality for data services provider 350 would be apparent to those skilled in the art.

Data repository or database 360 may for example provide information such as image data associated with a particular location, aerial maps, low latency access point names, virtual SIM information, asset management information, or other such information.

The types of information provided by data service provider 350 or the data repository or database 360 are not limited to the above examples and the information provided could be any data useful to server 340.

In some embodiments, information from data service provider 350 or the data repository from database 360 can be provided to one or more of sensor apparatuses 310, 312, or 314 for processing at those sensor apparatuses.

Utilizing the system and devices from FIGS. 2 and 3 above, methods and systems for leasing of assets are provided.

In accordance with one embodiment of the present disclosure, an asset management system may have a plurality of customers who may either provide or lease those assets. As such, each customer subscribes to the asset management system in order to provide information with regard to assets that the company is willing to lease or is looking to lease.

Such asset management system may, for example, be server 340 from the embodiment of FIG. 3.

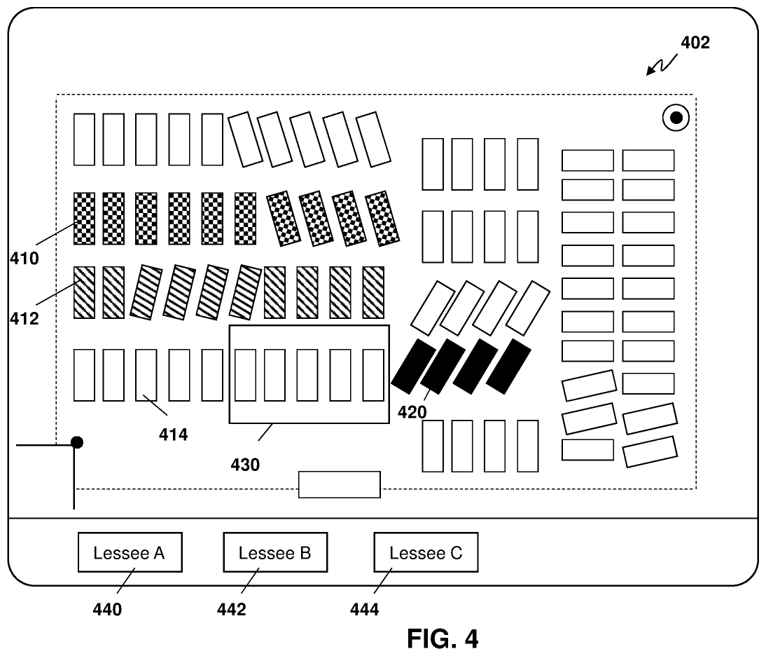

Thus, in one case, an asset screen may be provided to a first customer who is willing to lease assets. The first customer may be provided with information on the needs of other lessees and may therefore use the interface to lease assets. Reference is now made to FIG. 4.

The embodiment of FIG. 4 shows an example user interface 402 which may be used to manage and lease assets. The example of FIG. 4 is however provided for illustration purposes only and in other cases different user interfaces may be utilized.

In the example of FIG. 4, a representation of the shipping yard or geofence of FIG. 1 is provided to a lessor. This representation may provide an overview of the various assets within the yard. In some cases, the assets within the yard may be color-coded to indicate to the type of asset. Thus, for example, asset 410 is shown with a first color or pattern while asset 412 is shown with a second color or pattern. Asset 414 is shown without a pattern. Each color or pattern could represent that the asset is available for leasing and/or is a particular type of asset.

Further, assets 420 are shown with a further color and could represent that these assets are either full, already leased, or needed by the transportation company and therefore not available for lease.

In other cases, pulldown menus a could be used to filter or select only certain types of assets to be shown on the screen.

In other cases, rather than a graphical representation, an asset list may be provided it to a user. In this case, the asset list may be filtered based on geolocation or shipping yard, and may further be filtered by asset type, for example. Other types of filtering are possible.

Further, other types of graphical representations or text representations of assets may be provided to user, and the present disclosure is not limited to any particular representation of assets that is provided to a user.

The current number of available assets in a shipping yard could be detected in a variety of ways. As used herein, an asset may be any item which may be in the shipping yard, and includes various types of containers, railcars, vehicles such as trucks, and/or a combination of the above, among other options.

In one embodiment, a geofence may exist around the yard, and each vehicle or trailer may be equipped with the sensor apparatus as described above with regard to FIG. 2. The sensor apparatus may provide the positioning of the trailer or vehicle. In this regard, if the position is reported to be within the geofence then a tally may be made of all trailers or vehicles within the geofence to provide an indication of how many vehicles are currently within the yard. A report may similarly be generated on a vehicle exiting the geofence, allowing in the tally of assets within the shipping yard to be updated accordingly.

In other embodiments, the current number of assets in a yard may be detected in other ways. For example, a yard such as that described in FIG. 1 above may have a fixed number of entry or exit points 160. The entry or exit points may further include sensors to tally vehicles entering or leaving the yard. For example, such sensors may be cameras which may then be connected to a computer having image recognition software to detect when a vehicle leaves or enters the yard. Such image recognition may also detect the asset type, such as a flatbed trailer or refrigerator truck, for example.

In other cases, weight sensors, magnetic sensors, lasers, or other mechanisms for counting vehicles entering or exiting a yard may be utilized at the entrance and egress points of the yard to keep a tally of the number of assets within the yard. In this case, manual or automatic detection of the type of asset may be used.

In still further embodiments, the number of vehicles in a yard may be compiled by a sensor apparatus on a second vehicle. For example, the sensor apparatus on the second vehicle may include a camera which, when viewing the yard, may allow for a tally of the vehicles within the yard. In particular, the tally may be done by compiling image data at a server or other computing device from one or more vehicles with image capture devices. The second vehicle may be a shunt vehicle or other vehicle within the yard. In some cases, the second vehicle may be another trailer or vehicle that is moving to a parking spot which may provide data back to a server. In still further cases, the second vehicle may be a plurality of vehicles that include the sensor apparatus and the tally may be a composite of data provided by the plurality of the vehicles.

In still further embodiments, a fixed camera may be positioned, for example, on a pole or a crane, which may have a view of the yard or part of the yard and allow for image processing to determine the current number and type of assets in the yard or that part of the yard.

In still further embodiments, the number of assets in the shipping yard may be found by getting the GPS locations of all assets located within the geofence of the yard.

In still further embodiments, a yard tally may be entered by workers within the yard into a computing system. Thus a manual count by people is possible, with the data being entered into a computer system.

Other options for assessing the current number of assets currently within the yard are also possible.

Further, in order for an asset to be available, besides being present in the yard, it may need to be empty. In this regard, an asset may be determined to be empty through various mechanisms. In a first mechanism, a sensor apparatus such as that described above with regard to FIG. 2 may be used to determine whether the asset is empty. For example, the sensor apparatus may include a cargo detection system such as a laser and detector, a time of flight sensor, a camera and light, among other options. Such cargo detection system may be utilized to determine whether the asset is empty.

In other cases, if the asset is an open platform such as a flatbed trailer, image detection apparatuses when the vehicles in the yard, such as through a fixed camera on a pole or on moving cameras on other trailers or yard vehicles may be used to determine whether the open platform is loaded or not.

In further systems, a scale or weight system at the ingress point for the yard may determine if an empty trailer is being brought into the yard. For example, the weight of the trailer may indicate that it is empty.

In still further embodiments, once a trailer has been unloaded, information about the unloaded state of the trailer may be propagated to a computing device and utilized for a pool management asset system.

In still further embodiments, a yard tally may be entered by workers within the yard into a computing system indicating assets which are empty. Thus a manual count by people is possible, with the data being entered into a computer system.

In still further embodiments, an asset may not be available if it is scheduled to be utilized for another delivery. In this case, a delivery system may be cross-referenced with that the asset management system to ensure that assets are not allocated twice.

For example, when inputting a delivery, a customer of the transportation service may specify the type of asset that is required for such delivery. In other cases, default asset types might be provided it to a customer, and in this case, a customer may need to change such default asset type if a different type of asset is needed.

In some cases, the customer of the transportation company may set a delivery time and/or location. In this case, the need for the asset can be time limited to allow the asset to be freed for future uses after the delivery is completed.

By specifying the asset type needed for a delivery, an asset management system can determine whether such class or type of asset exists within the yard or geofence.

Further, while available assets may be shown with a current timestamp, in some cases, future availability may be needed. For example, if the lease is for a future time, then the assets that will be available at that future time are needed. In this case, the assets may be correlated with booking or shipping data to find future availability.

In particular, from shipment information, a transportation management system may know when assets are scheduled to enter or leave a yard. Such information may be utilized to project future availability of assets in the yard.

For example, if assets are allocated to future deliveries, then when a new delivery is scheduled those same assets cannot be allocated to such new delivery unless the assets will be free by the time the delivery is scheduled.

In other cases, scheduled deliveries into the yard or geofence may leave a trailer or other asset free for future deliveries. In this case, the timing of the arrival of the asset at the yard, along with an unloading time, may be considered by the asset management system.

The future information may, in some cases, include a buffer time around the scheduled arrival. In this way, assets that arrive late can be still be included in the tally of available assets based on the buffer.

Further, the future information may be correlated to sensor data on a vehicle or trailer. For example, an asset that is scheduled to arrive in two hours but is showing from its GPS positioning and that it is at least three hours away from the yard could allow for the calculation of available assets be adjusted accordingly. Similarly, when an asset clears a border crossing more quickly than scheduled, this may bring forward the arrival time of the asset at the yard and allow the yard to adjust available assets accordingly.

Based on the values, a future projection for available assets may be made. Such future projection may then be provided on a user interface such as that described with regard to FIG. 4 for future leasing of assets.

In the embodiment of FIG. 4, a lessor may be notified that a lessee is looking for a particular number of assets. In this case, the lessor may select one or more assets. The selection, for example, may include drawing a box such as box 430 around the desired number of assets. Rather than a box, any shape may be used. Further, instead of drawing a shape, the assets could be selected individually and grouped together. For example, in some cases the operator may hold the shift key down while selecting assets to indicate that a plurality of assets are being selected.

In the case of a text representation, a check box may be provided to select assets. In other cases, the assets may be highlighted in other ways or selected in other ways. For example, a user may be able to draw one or more loops around one or more assets to select the one or more assets within the loop. The loop may be drawn on a map using a suitable user interface. A user may also be able to tap on or click one or more assets shown on the map to effect selection. The user interface may provide the map enters an asset selection mode in order to enable selection of the assets. Drawing a loop around assets shown on a map allows an easy way to distinguish assets visually rather than having to make use of asset IDs, which in a system with a large number of assets can be very laborious.

Once one or more assets are selected, for example utilizing box 430, the one or more assets may be dragged to a particular lessee. Boxes 440, 442 and 444 show various lessees which allow for an operator to drag a box 430 to these lessees to lease the asset to the particular lessee.

Again, instead of boxes, various options for leasing could be provided. This may include, for example, a menu. Thus when an operator right clicks within box 430 a list of lessees may be provided. In other cases, rather than a box, other icons or representations of the various lessees may be provided to an operator.

Once the assets are dragged or otherwise allocated to a particular lessee, an operator for the lessor may be prompted to ensure that the action was desired. For example, a pop up may be presented on user interface 402. However, the prompt to ensure the action was desired is an optional step.

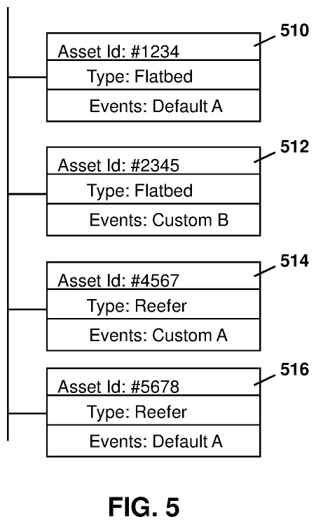

The actual allocation of the assets may be done in a variety of ways. The assets themselves will typically be represented in the asset management system utilizing a database. For example, reference is now made to FIG. 5.

In the embodiment of FIG. 5 a variety of assets are shown within a database. For example, in the example of FIG. 5, four assets are shown. These assets are labelled as asset 510, 512, 514 and 516.

In the example of FIG. 5, each asset includes an identifier, an asset type, and an event filter. However, such fields are merely provided as examples and in practice each asset could have more or fewer fields and may not include the particular fields shown in the embodiment of FIG. 5.

In the case of the transportation of goods, the event filter may allow for data from a sensor apparatus such as that shown with regard to FIG. 2 to be filtered and provide a notification or prompt an action based on the event filter.

Thus, for example, if the sensor apparatus is associated with a trailer, the event filter may include temperature thresholds. For example, if the asset is a reefer truck, then temperature thresholds may be set to just below freezing, and if the temperature exceeds this threshold then an alert or other notification may be provided to the owner of the asset.

Similarly, geofences may be assigned for each asset, which may provide for notifications or alarms if the asset enters or leaves such geofences.

Other thresholds or parameters can be set into the event filter to provide for actions or notifications based on such events.

In some cases, a transportation company may have default policies. The default policy may be based on an asset type and may set certain specific thresholds or values for event filtering. This default policy may be assigned to each asset and may then be modified as required by the operator of the asset.

Thus, in the embodiment of FIG. 5, the event filters are shown as default or custom, and may have more granularity by providing a specific default policy or a specific custom policy.

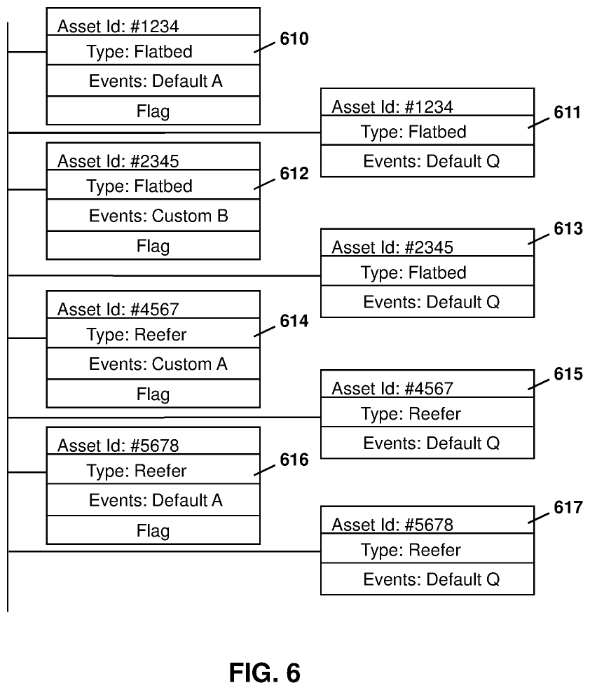

In accordance with one embodiment of the present disclosure, once an asset is leased, the database entry for the asset may be duplicated within the asset management system. Reference is now made to FIG. 6.

In the embodiment of FIG. 6, the entries 610, 612, 614 and 616 correspond with entries 510, 512, 514 and 516 from FIG. 5, with the exception that a flag or pointer may be added to such entries.

Upon an operator assigning certain assets to a lessee, the assets may then be duplicated in the database. Thus, as shown in FIG. 6, entry 611 is a duplication of entry 610. Entry 611 is however associated with the lessee. Further, a default event filter that corresponds with the lessee may be assigned to the asset entry.

Similarly, entry 613 is a duplication of entry 612 with a default policy associated with the lessee assigned to it.

Entry 615 is a duplication of entry 614 with a default policy associated with the lessee assigned to it.

Entry 617 is a duplication of entry 616 with a default policy associated with the lessee assigned to it.

A flag and/or a pointer may be provided in the original entry to indicated that such asset has been leased, and provide a pointer to the duplicate record. Therefore, the flag on entry 610 would point to entry 611. Similarly the flag on entry 612 would point to entry 613. The flag on entry 614 would point entry 615. Also, the flag on entry 616 would point to entry 617.

In this way, when a sensor apparatus such as that described above with regard to FIG. 2, and associated with a particular asset, sends data to the asset management system, the asset management system can identify the entry in the database associated with the sensor apparatus and extract the event filters. The event filters could identify whether the data within the packet received from the sensor apparatus should cause an alert or other action to be performed.

However, because the entry is duplicated, as provided with the flag and/or pointer, the data may then be processed again based on the event filters associated with the duplicate asset record. In this case, the alert or notification may be provided to the lessee rather than the lessor.

Further, in some cases, a default policy on an asset may change when the asset is leased. In this case, the event filters on the lessor may be assigned a default policy temporarily while the asset is leased. For example, the lessor may not care about over temperature conditions, but may care but sudden acceleration or deceleration events which may jeopardize of the asset. Conversely, the lessee that is transporting goods using the leased asset may care about over temperature conditions. In each case, both of the lessor and the lessee may receive notifications based on the event filters assigned for the asset.

Once the asset is returned to the lessor, the duplicate entries, namely entries 611, 613, 615 and 617, may be deleted. Prior to deleting the entry, the lessor may in some cases need to confirm that the asset has been returned.

Deleting the entry may also delete the flags and pointers in the original entry associated with that they lease.

Further, in some cases, lease information for the asset may be stored in the original entry for that asset. In this way, the lessor may be able to identify who has previously leased the asset and the history of the asset.

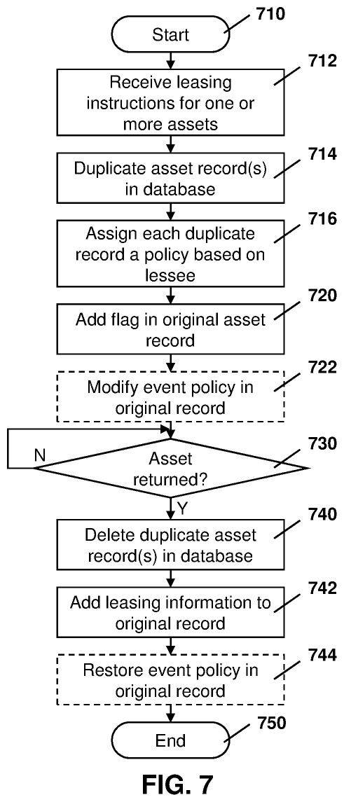

Therefore, one example of a process of leasing an asset at a server is provided with regard to FIG. 7. The process of FIG. 7 starts at block 710 and proceeds to block 712, in which an asset management server may receive leasing instructions for one or more assets. Leasing instructions may, for example, be received based on operator interaction with the user interface such as user interface 402 from FIG. 4. In other embodiments, leasing instructions may be received from other computing devices based on prearranged contracts, based on operator interactions with lists, among other options.

The process then proceeds to block 714 in which the leasing instructions are parsed to determine the original asset records. These asset records are then duplicated in the database based on the received leasing instructions. Such duplication is, for example, shown above with regard to FIG. 6.

The process then proceeds to block 716 in which each duplicate record is assigned a policy based on the lessee. As indicated above, the policy may be default event filters for the particular type of asset for the lessee.

The process then proceeds to block 720 in which a flag or pointer may be added to the original asset record to indicate that the duplicate record exists and the location of the duplicate record.

From block 720 the process proceeds to block 722 and optionally may modify the event policy in the original record. For example, a lessor may have default policies for particular asset types when the asset is leased. In this case, those default policies for a leased asset may be applied to the original record. Thus, when performing event filtering, the new event policy may be used to provide alerts which are of interest to the lessor based on the status of the asset.

From block 722, or from block 720 if block 722 is not part of the process, the process then proceeds to block 730 in which a check is made to determine whether the asset has been returned. If the asset has not been returned, the process continues to wait for the asset to be returned at block 730. As indicated above, the asset being returned may involve confirmation by the lessor of the asset being returned.

Once the asset is returned, the process proceeds to block 740 in which the duplicate asset record is deleted from the database.

The process may then proceed to block 742 in which leasing information about the asset may be added to the original record to provide the lessor with a leasing history for that asset.

From block 742, the process may optionally proceed to block 744 in which the event policy is restored in the original record. As will be appreciated by those in the art, if the policy was modified at block 722, once the lease is finished the original policy may need to be restored. This may involve storing the original policy in a location associated with the asset and then restoring such policy once the lease is concluded.

From block 744, or from block 742 if the process avoids block 744, the process then proceeds to block 750 and ends.

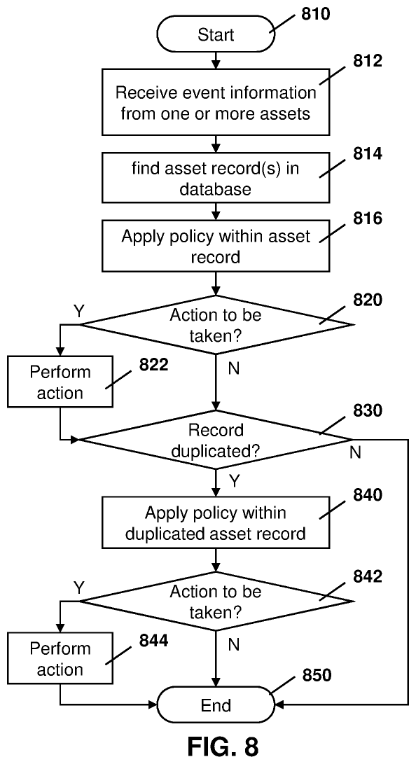

One process for reacting to sensor data is shown in FIG. 8. In particular, the process of FIG. 8 starts at block 810 and proceeds to block 812 in which event information may be received from one or more assets. Such event information may, for example, include a packet of data with the various sensor readings. The data may be configured in a particular format and may be receive periodically from each asset. Further, in some cases the event data may be received based on a sensor apparatus detecting anomalous conditions.

From block 812, the process proceeds to block 814 in which asset records associated with the event data received at block 812 are found. In this case, the event records which are found are associated with the customer or lessor.

The process then proceeds to block 816 in which policies within the found asset records are applied to the event data received at block 812. For example, the policies within the record may indicate that the customer or lessor wants to know when over-temperature conditions exist, when sudden deceleration events occur, when a vehicle has entered or exited or geofence, among other options.

Once the policies are applied to the event data, the process proceeds to block 820 in which a determination is made on whether an action should be taken. For example, the action should be taken if thresholds are met, if geofence locations are exited or entered, among other options.

If an action is to be taken, the process proceeds to block 822 in which the action is performed. Such action may include alerting an operator, alerting a driver, providing audio, sensory, or visual cues, redirecting autonomous vehicles, among other options.

From block 820, if no action is to be taken, or from block 822, the process proceeds to block 830 in which a check is made to determine whether the record is duplicated. For example, this may involve checking whether the original record includes a flag or pointer to a duplicate record.

If the record is duplicated, the process proceeds to block 840 in which a policy within the duplicate asset record is applied to the event data. For example, such policy may be associated with the lessee of the asset.

From block 840, the process proceeds to block 842 in which a check is made to determine whether an action should be taken based on the processing at block 840. If an action is to be taken, the process proceeds to block 844 in which the action is performed. The actions performed at block 822 and 844 may be different in some cases. Further, the checks at block 820 and block 842 may be different based on the different event policies within the original and duplicate records.

From block 844, or if no action needs to be taken from block 842, the process proceeds to block 850 and ends.

Further, from block 830, if the record is not duplicated in the process proceeds to block 850 and ends.

Based on the above, assets may be leased easily by selecting one or more assets for example on a user interface and performing bulk leasing actions. The actions allow for the records to be duplicated in the database temporarily while of the asset is leased, thereby allowing different policies to be applied based on the interested party. Once the asset is returned, the duplicate record may be deleted from the database and any event policies restored for the lessor.

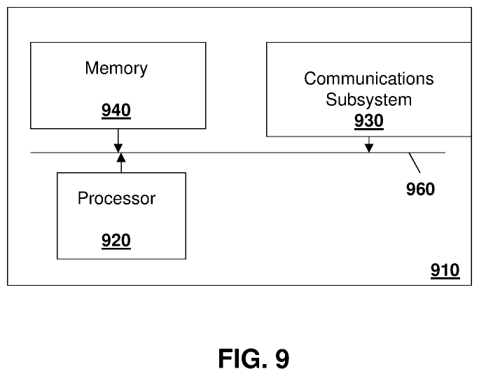

A server such as servers 340, 342 or 350 may be any network node. For example, one simplified server that may perform the embodiments described above is provided with regards to FIG. 9.

In FIG. 9, server 910 includes a processor 920 and a communications subsystem 930, where the processor 920 and communications subsystem 930 cooperate to perform the methods of the embodiments described herein.

The processor 920 is configured to execute programmable logic, which may be stored, along with data, on the server 910, and is shown in the example of FIG. 9 as memory 940. The memory 940 can be any tangible, non-transitory computer readable storage medium, such as optical (e.g., CD, DVD, etc.), magnetic (e.g., tape), flash drive, hard drive, or other memory known in the art. In one embodiment, processor 920 may also be implemented entirely in hardware and not require any stored program to execute logic functions.

Alternatively, or in addition to the memory 940, the server 910 may access data or programmable logic from an external storage medium, for example through the communications subsystem 930.

The communications subsystem 930 allows the server 910 to communicate with other devices or network elements.

Communications between the various elements of the server 910 may be through an internal bus 960 in one embodiment. However, other forms of communication are possible.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be employed. Moreover, the separation of various system components in the implementation descried above should not be understood as requiring such separation in all implementations, and it should be understood that the described program components and systems can generally be integrated together in a signal software product or packaged into multiple software products. In some cases, functions may be performed entirely in hardware and such a solution may be the functional equivalent of a software solution

Also, techniques, systems, subsystems, and methods described and illustrated in the various implementations as discrete or separate may be combined or integrated with other systems, modules, techniques, or methods. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and may be made.

While the above detailed description has shown, described, and pointed out the fundamental novel features of the disclosure as applied to various implementations, it will be understood that various omissions, substitutions, and changes in the form and details of the system illustrated may be made by those skilled in the art. In addition, the order of method steps is not implied by the order they appear in the claims.

When messages are sent to/from an electronic device, such operations may not be immediate or from the server directly. They may be synchronously or asynchronously delivered, from a server or other computing system infrastructure supporting the devices/methods/systems described herein. The foregoing steps may include, in whole or in part, synchronous/asynchronous communications to/from the device/infrastructure. Moreover, communication from the electronic device may be to one or more endpoints on a network. These endpoints may be serviced by a server, a distributed computing system, a stream processor, etc. Content Delivery Networks (CDNs) may also provide may provide communication to an electronic device. For example, rather than a typical server response, the server may also provision or indicate a data for content delivery network (CDN) to await download by the electronic device at a later time, such as a subsequent activity of electronic device. Thus, data may be sent directly from the server, or other infrastructure, such as a distributed infrastructure, or a CDN, as part of or separate from the system.

Typically, storage mediums can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

In particular, the present disclosure may include the embodiments of the following clauses:

AA. A method at a computing device within an asset management system, the method comprising: receiving a leasing indication at the computing device, the leasing indication providing at least one asset in the asset management system is leased to a lessee; duplicating an asset record for each of the at least one asset, created a duplicated record; assigning a policy based on the lessee to the duplicated record; and providing a pointer within the asset record to the duplicated record.

BB. The method of clause AA, wherein the leasing indication is based on selection and assignment on a user interface of the computing device of the at least one asset to the lessee.

CC. The method of clause BB, wherein a plurality of assets is selectable at once.

DD. The method of clause CC, wherein the duplicating occurs for each of the plurality of assets.

EE. The method of any one of clauses BB to DD, wherein the user interface includes a box or bucket for each lessee, whereby each asset or group of assets can be dragged to the box or bucket to provide the leasing indication.

FF. The method of any one of clauses AA to EE, further comprising: receiving an indication that the at least one asset has been returned; and deleting the duplicated record for the at least one asset.

GG. The method of any one of clauses AA to FF, further comprising: receiving sensor data for the at least one asset; using a policy for a lessor to the sensor data; applying the assigned policy to process the sensor data based on a policy for the lessee; and providing separate reports to the lessor and lessee based on the using and applying steps.

HH. The method of any one of clauses AA to GG, further comprising: modifying a policy for the at least one asset for the lessor upon receiving the leasing indication; and restoring the policy for the asset for the lessor once the at least one asset is returned.

II. The method of any one of clauses AA to HH, further comprising modifying the asset record to include information about the lease.

JJ. The method of any one of clauses AA to II, further comprising redirecting the at least one asset to a location associated with the lessee.

KK. A computing device within an asset management system, the computing device comprising: a processor; and a communications subsystem, wherein the computing device is configured to: receive a leasing indication at the computing device, the leasing indication providing at least one asset in the asset management system is leased to a lessee; duplicate an asset record for each of the at least one asset, created a duplicated record; assign a policy based on the lessee to the duplicated record; and provide a pointer within the asset record to the duplicated record.

LL. The computing device of clause KK, wherein the leasing indication is based on selection and assignment on a user interface of the computing device of the at least one asset to the lessee.

MM. The computing device of clause LL, wherein a plurality of assets is selectable at once.

NN. The computing device of clause MM, wherein the computing device is configured to duplicate the asset record for each of the plurality of assets.

OO. The computing device of any one of clauses LL to NN, wherein the user interface includes a box or bucket for each lessee, whereby each asset or group of assets can be dragged to the box or bucket to provide the leasing indication.

PP. The computing device of any one of clauses KK to OO, wherein the computing device is further configured to: receive an indication that the at least one asset has been returned; and delete the duplicated record for the at least one asset.

QQ. The computing device of any one of clauses KK to PP, wherein the computing device is further configured to: receive sensor data for the at least one asset; use a policy for a lessor to the sensor data; apply the assigned policy to process the sensor data based on a policy for the lessee; and provide separate reports to the lessor and lessee based on the using and applying steps.

RR. The computing device of any one of clauses KK to QQ, wherein the computing device is further configured to: modify a policy for the at least one asset for the lessor upon receiving the leasing indication; and restore the policy for the asset for the lessor once the at least one asset is returned.

SS. The computing device of any one of clauses KK to RR, wherein the computing device is further configured to modify the asset record to include information about the lease.

TT. The computing device of any one of clauses KK to SS, wherein the computing device is further configured to redirect the at least one asset to a location associated with the lessee.

UU. A computer readable medium for storing instruction code which, when executed by a processor of a computing device within an asset management system, cause the computing device to: receive a leasing indication at the computing device, the leasing indication providing at least one asset in the asset management system is leased to a lessee; duplicate an asset record for each of the at least one asset, created a duplicated record; assign a policy based on the lessee to the duplicated record; and provide a pointer within the asset record to the duplicated record.

1. A computing device comprising:
a processor; and
a communications subsystem, wherein the computing device is configured to:
maintain, in a database accessible to the computing device, a plurality of records, wherein each record of the plurality of records corresponds to an asset and comprises an asset identifier and a policy, the policy defining conditions and an action to be performed upon the conditions being met;
receive, from a user interface of the computing device, a selection of a selected asset and a third party, the third party being associated to a default policy; create, in the database, a duplicate record of a record associated to the selected asset;
modify the duplicate record to comprise the default policy of the third party; modify the record associated to the selected asset to include a pointer to the duplicate record;
receive sensor data associated to the selected asset;
obtain, from the record associated to the selected asset, a first policy defining first conditions and a first action;
perform the first action when the first conditions are satisfied by the sensor data;
obtain, from the duplicate record, a second policy defining second conditions and a second action; and
perform the second action when the second conditions are satisfied by the sensor data.

2. The computing device of claim 1, wherein the user interface comprises an icon for each asset corresponding to each of the plurality of records.

3. The computing device of claim 2, wherein the user interface further comprises an area of a display of the computing device associated to the third party.

4. The computing device of claim 3, wherein the selection comprises a drag-and-drop of the icon corresponding to the selected asset into the area of the display associated to the third party.

5. The computing device of claim 2, wherein each icon of the user interface is color-coded to indicate an availability of a corresponding asset.

6. The computing device of claim 1, further configured to:
receive a new policy for the selected asset;
modify the duplicate record to include the new policy.

7. The computing device of claim 1, wherein the user interface displays an icon for each asset located in a geofence.

8. The computing device of claim 7, wherein a given asset is determined to be located in the geofence based on data received from a location sensor of the given asset.

9. The computing device of claim 7, wherein a given asset is determined to be located in the geofence based on data received from sensors located at ingress and egress points of the geofence.

10. A method at a computing device, comprising:
maintaining, in a database accessible to the computing device, a plurality of records, wherein each record of the plurality of records corresponds to an asset and comprises an asset identifier and a policy, the policy defining conditions and an action to be performed upon the conditions being met;
receiving, from a user interface of the computing device, a selection of a selected asset and a third party, the third party being associated to a default policy; creating, in the database, a duplicate record of a record associated to the selected asset;
modifying the duplicate record to comprise the default policy of the third party;
modifying the record associated to the selected asset to include a pointer to the duplicate record;
receiving sensor data associated to the selected asset;
obtaining, from the record associated to the selected asset, a first policy
defining first conditions and a first action;
performing the first action when the first conditions are satisfied by the sensor data;
obtaining, from the duplicate record, a second policy defining second conditions and a second action; and
performing the second action when the second conditions are satisfied by the sensor data.

11. The method of claim 10, wherein the user interface comprises an icon for each asset corresponding to each of the plurality of records.

12. The method of claim 11, wherein the user interface further comprises an area of a display of the computing device associated to the third party.

13. The method of claim 12, wherein the selection comprises a drag-and-drop of the icon corresponding to the selected asset into the area of the display associated to the third party.

14. The method of claim 11, wherein each icon of the user interface is color-coded to indicate an availability of a corresponding asset.

15. The method of claim 10, further comprising:
receiving a new policy for the selected asset;
modifying the duplicate record to include the new policy.

16. The method of claim 10, wherein the user interface displays an icon for each asset located in a geofence.

17. The method of claim 16, wherein a given asset is determined to be located in the geofence based on data received from a location sensor of the given asset.

18. The method of claim 16, wherein a given asset is determined to be located in the geofence based on data received from sensors located at ingress and egress points of the geofence.

19. A non-transitory computer readable medium having stored thereon executable code for execution by a processor of a computing device, the executable code comprising instructions for:
maintaining, in a database accessible to the computing device, a plurality of records, wherein each record of the plurality of records corresponds to an asset and comprises an asset identifier and a policy, the policy defining conditions and an action to be performed upon the conditions being met;
receiving, from a user interface of the computing device, a selection of a selected asset and a third party, the third party being associated to a default policy;
creating, in the database, a duplicate record of a record associated to the selected asset;
modifying the duplicate record to comprise the default policy of the third party;
modifying the record associated to the selected asset to include a pointer to the duplicate record;
receiving sensor data associated to the selected asset;
obtaining, from the record associated to the selected asset, a first policy defining first conditions and a first action;
performing the first action when the first conditions are satisfied by the sensor data;
obtaining, from the duplicate record, a second policy defining second conditions and a second action; and
performing the second action when the second conditions are satisfied by the sensor data.
